(19) United States
(12) Patent Application Publication
(10) Pub. No.: US 2010/0138205 A1
(43) Pub. Date: Jun. 3, 2010

(54) STOCHASTIC MOLECULAR BINDING SIMULATION

(75) Inventors: Kevin Y. Sanbonmatsu, Santa Fe, NM (US); Paul Whitford, Santa Fe, NM (US); Jose Onuchic, San Diego, CA (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: LOS ALAMOS NATIONAL SECURITY, LLC, Los Alamos, NM (US)

(21) Appl. No.: 12/578,433

(22) Filed: Oct. 13, 2009

Related U.S. Application Data
(60) Provisional application No. 61/195,858, filed on Oct. 10, 2008.

(51) Int. Cl. G06G 7/58

(52) U.S. Cl. 703/12

(57) ABSTRACT

The invention provides methods of dynamically simulating molecular interactions between a target molecule and a plurality of ligand molecules. The ligand molecules may be presented in the model as a homogeneous set of identical ligands or as a heterogeneous set of different ligands, such as, for example, a set of structural variants of a ligand molecule. Typically, the ligand molecule will be a small organic compound, such as a drug or other small molecule, and the ligand will be a protein or a protein domain, a nucleic acid (i.e., DNA, RNA), or a biomolecular complex of proteins and/or nucleic acid molecules. Unlike all known molecular dynamics simulation methods, the invention provides ligand molecules to the simulation's interaction environment(s) in excess relative to the target molecule.

### RELATED APPLICATIONS

This application claims priority to U.S. Provisional Application No. 61/195,858 filed on Oct. 10, 2008.

### STATEMENT AS TO RIGHTS TO INVENTIONS MADE UNDER FEDERALLY SPONSORED RESEARCH OR DEVELOPMENT

This invention was made with government support under Contract No. DE-AC52-06 NA 25396 awarded by the U.S. Department of Energy. The government has certain rights in the invention.

### BACKGROUND OF THE INVENTION

Structure-based models have had considerable success in expanding our understanding of biomolecular folding and function. Many models have been coarse-grained, such that each residue is represented by a single bead. Recent work has been able to extend the C-alpha model to an all-atom representation for structure-based simulations of biomolecules. In contrast to several previous models, this class of models not only includes all heavy (non-hydrogen) atoms, but it is also completely structure-based. That is, the global energetic minimum is the native structure (i.e., as determined by the PDB structure).

Protein dynamics take place on many time and length scales. Coarse-grained structure-based (Go) models utilize the funneled energy landscape theory of protein folding to provide an understanding of both long time and long length scale dynamics. All-atom empirical forcefields with explicit solvent have been useful for elucidating our understanding of short time dynamics with high energetic and structural resolution. The theory states that proteins are minimally frustrated, that their energy landscape is funnel shaped and that the folded state of the protein is at the bottom of the funnel. Because of the shape of the landscape there is a strong energetic bias towards the folded state of the protein with relatively infrequent trapping caused by non-native interactions. The resulting heterogeneity observed during folding is due to the geometric constraints of the native structure. Thus, models of proteins that have only the native structure encoded have had great success in determining folding mechanisms.

Until recently, most models tended to be coarse-grained, which are very useful in understanding global folding dynamics. In commonly used structure-based (Go) potentials (Clementi et al., 2000, J. Mol. Biol. 298: 937-953), each residue is represented by a bead centered at the location of the Cα atom and only native interactions are stabilizing.

On the other end of the spectrum of structural and energetic details are the computationally intensive all-atom empirical forcefields (for review, see Adcock et al., 2006 Molecular dynamics: a survey of methods for simulating the activity of proteins, Chem, Rev. 106: 1589-1615). These forcefields include an atomistic representation of a protein either with an implicit or an explicit solvent. In these potentials, the parameters which determine the interaction between atoms, such as partial charges and van der Waals radii, are fit to experimental measurements and quantum mechanical calculations. With accurate calibration, a single parameter set may be applied to any protein and, with sufficient computing resources, the dynamics of a protein can be calculated on a computer. The physics-based representation of atom-atom interactions automatically includes electrostatic interactions as well as any non-native interactions that may be present.

In principle, these models render knowledge of a native structure unnecessary. A major limitation of these potentials is that they are often too expensive to fold all but small proteins. The timescales that can currently be calculated vary from hundreds of nanoseconds to microseconds, depending on the size of the protein. Biological timescales are usually several orders of magnitude larger and these dynamics cannot be accessed using all-atom empirical forcefields. In addition, sensitivity analysis of the dynamics to the parameters is not possible with these all-atom empirical forcefields. In all-atom empirical forcefields an observed specificity of (i.e., preference for) native interactions is seen as a consequence of many energetic contributions. Because of the complex formulation of these potentials, it is impossible to partition geometric effects from energetic ones. There is a similar restriction in coarse-grained models because of their simplicity. Partitioning these effects is often impossible because geometry is included implicitly through energetic interactions.

Recently, an all-atom structure based model which bridges the gap between coarse-grained models and all-atom empirical forcefield models was described (Whitford et al., 2008, An all-atom structure-based potential for proteins: Bridging minimal models with all-atom empirical forcefields, Proteins: Structure, Function, and Bioinformatics 75(2): 430-441).

To date, many computational drug design strategies begin with a single small molecule located at or near the binding site on the target. A free energy function is used that includes enthalpic terms but does not explicitly account for entropy (i.e., does not determine the free energy by counting states). Often, an empirical or semi-empirical entropy term determined by calibration with experiment is used. The molecule and target are then rotated, translated and deformed to minimize the free energy. These perturbations can be stochastic.

### SUMMARY OF THE INVENTION

The invention provides methods of dynamically simulating molecular interactions between a target molecule and a plurality of ligand molecules. The ligand molecules may be presented in the model as a homogeneous set of identical ligands or as a heterogeneous set of different ligands, such as, for example, a set of structural variants of a ligand molecule. Typically, the ligand molecule will be a small organic compound, such as a drug or other small molecule, and the ligand will be a protein or a protein domain, a nucleic acid (i.e., DNA, RNA), or a biomolecular complex of proteins and/or nucleic acid molecules. Unlike all known molecular dynamics simulation methods, the invention provides ligand molecules to the simulation's interaction environment(s) in excess relative to the target molecule.

In one aspect, the invention provides a method of simulating the interaction between a ligand and a target molecule, in which a computer-generated interaction environment having volumetric dimensions as large or larger than the known or predicted maximum volume of the target molecule, the interaction environment is populated with the three-dimensional structure of a single target molecule and a plurality of ligand molecules, wherein the ligand molecules are positioned at least three times the estimated diameter of the ligand molecule from the target molecule, and, a molecular dynamics simulation is conducted, in which the free energy includes entropy. The interaction dynamics between one or more ligand molecules and the target molecule are observed, recorded, displayed and/or output for interpretation. In some embodiments, the molecular dynamics simulation is conducted for a time sufficient for the simulation to converge. The three-dimensional structures of the target and ligand molecules are derived using experimentally-derived or predicted structures or a combination thereof (i.e., x-ray crystallography to generate a “crystal structure” of the molecule, nuclear magnetic resonance, cryo electron microscopy, small angle x-ray scattering and the like, computer modeling, and combinations thereof). Typically, the interaction dynamics of interest will include binding events between he ligand(s) and the target molecule. In the practice of the methods of the invention, the user may select parameters for what constitutes a binding event. In one embodiment, a distance of 4 angstroms between a ligand molecule and the target molecule is set to define a binding event.

The plurality of ligand molecules are randomly placed within the interaction environment. Individual ligand molecules populating the interaction environment may be homogeneous or heterogeneous. Any number of ligand molecules may be used to populate the interaction environment. Typically, at least 10 ligand molecules are used to populate the interaction environment. In some embodiments, a greater number of ligands may be used to populate the interaction environment, such as, for example, 20, 30, 40, 50, 60, 70, 80, 90 or 100 or more ligand molecules.

In a related embodiment, the invention provides a method of simulating the interaction between a ligand and a target molecule, in which a plurality of computer-generated interaction environments are provided. Each such interaction environment is identical except for temperature and/or pressure and/or the effective strength of the interaction potential, wherein each interaction environment has a volumetric dimension as large or larger than the predicted maximum volume of the target molecule, and wherein the plurality of interaction environments represents a temperature range (or pressure or interaction potential strength range). Each interaction environment is populated with an identical set of molecules, comprising a single target molecule and a plurality of ligand molecules, wherein the ligand molecules are positioned at least three times the estimated diameter of the ligand molecule from the target molecule. Identical molecular dynamics simulations within each interaction environment are conducted, and the interaction dynamics between one or more ligand molecules and the target molecule observed in each environment, so as to enable comparisons and analyses of the interaction dynamics among the plurality of temperature-variable interaction environments. Throughout the simulation, temperature parameters (or pressure or potential interaction strength parameters) of interaction environments are exchanged to maximize configurational sampling. In one embodiment, for example, the temperature range is between 265 and 550 degrees Kelvin. Temperature intervals may be experimentally selected as desired. For example, intervals within the temperature range may be set at between one-tenth of a degree and 20 degrees Kelvin.

The simulation methods of the invention may further comprising generating a physical representation of the interaction between a ligand molecule and the target molecule. In one embodiment, the physical representation is a two dimensional image, a series of two-dimensional images, a movie, or numerical data which display or represent the interaction.

### BRIEF DESCRIPTION OF THE DRAWINGS

FIG. 1. Model of SAM-I riboswitch and ligands in a box format interaction environment.

FIG. 2. Schematic representation of box (A) and cloud (B) models of the interaction environment.

FIG. 3. Schematic representation of shadow contact map.

### DETAILED DESCRIPTION OF THE INVENTION

### Definitions

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art.

The term “nucleic acid” refers to deoxyribonucleotides or ribonucleotides and polymers thereof (“polynucleotides”) in either single- or double-stranded form. Unless specifically limited, the term “polynucleotide” encompasses nucleic acids containing known analogues of natural nucleotides which have similar binding properties as the reference nucleic acid and are metabolized in a manner similar to naturally occurring nucleotides. Unless otherwise indicated, a particular nucleic acid sequence also implicitly encompasses conservatively modified variants thereof (e.g. degenerate codon substitutions) and complementary sequences and as well as the sequence explicitly indicated. Specifically, degenerate codon substitutions may be achieved by generating sequences in which the third position of one or more selected (or all) codons is substituted with mixed-base and/or deoxyinosine residues (Batzer et al., 1991, Nucleic Acid Res. 19: 5081; Ohtsuka et al., 1985 J. Biol. Chem. 260: 2605-2608; and Cassol et al., 1992; Rossolini et al., 1994, Mol. Cell. Probes 8: 91-98). The term nucleic acid is used interchangeably with gene, cDNA, and mRNA encoded by a gene.

The terms “polypeptide,” “peptide” and “protein” are used interchangeably herein to refer to a polymer of amino acid residues. The terms apply to amino acid polymers in which one or more amino acid residue is an artificial chemical mimetic of a corresponding naturally occurring amino acid, as well as to naturally occurring amino acid polymers and non-naturally occurring amino acid polymers. A polypeptide or protein “fragment” refers to a polypeptide consisting of only a part of the intact full-length polypeptide sequence and structure. The fragment may include a C-terminal deletion and/or an N-terminal deletion of the native or other progenitor polypeptide.

### Stochastic Molecular Binding Simulations

In one aspect, the invention provides a method of simulating the interaction between a ligand and a target molecule, in which stochastic motion and stochastic binding between the ligand and target molecules is implemented. In the practice of the method of the invention, ligand molecules are provided to the simulation's interaction environment in excess relative to the target molecule. In one embodiment, a combination of a single target molecule and a plurality of ligand molecules are provided to the simulation's interaction environment. In another embodiment, ligand molecules are provided in a simulated molarity in order to approximate physiological conditions present in the natural biological environment in which the ligand molecules may interact with the target, such as a cellular environment. Typically, the ligand molecules will be provided at a ratio of between 10-1 and 100-1 relative to the target molecule, although ratios which exceed this range may be applied.

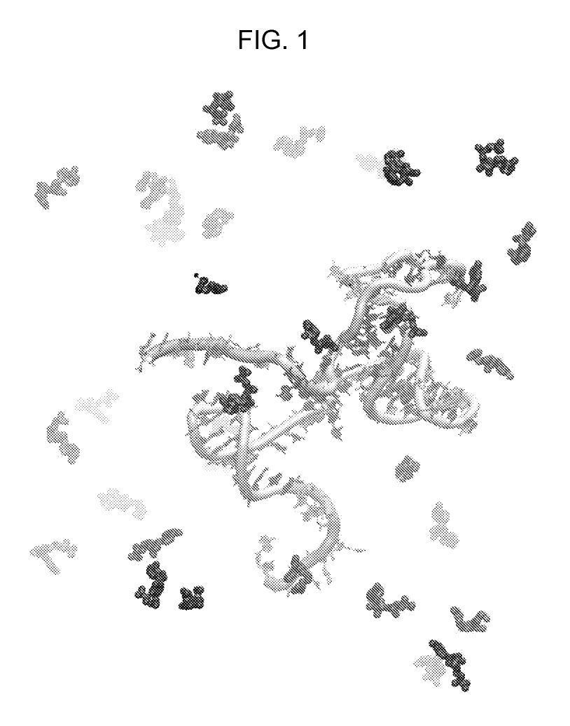

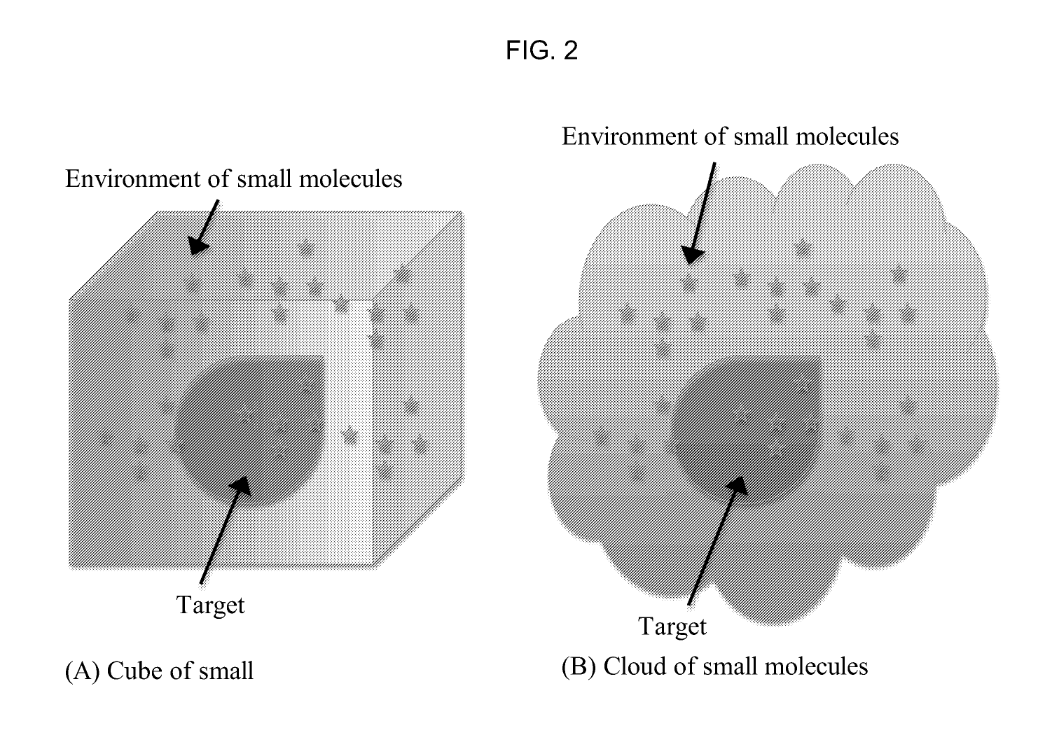

The method provides a computer-generated interaction environment in which the stochastic motion and binding interactions between ligand molecules and the target are simulated. The interaction environment may be constructed to adopt any three dimensional conformation. In one embodiment, the interaction environment may be constructed as a three-dimensional box of a size sufficient to accommodate the size of the target molecule and a plurality of ligand molecules in which the target is immersed (FIGS. 1 and 2A). In another embodiment, the interaction environment may be constructed to adopt a three-dimensional space sufficient to accommodate a cloud of ligand molecules surrounding the target (FIG. 2B). The interaction environment is constructed to have a volumetric dimension which is at least as large as the predicted maximum volume of the target molecule. Typically, the interaction environment will be larger than the predicted maximum volume of the target molecule, preferably between 15% to 100% larger.

The target molecule may be a protein, polypeptide fragment or domain thereof, a complex thereof, a nucleic acid molecule (e.g., DNA, RNA), or a complex thereof. Typically, the target molecule is a protein in relation to which the simulation models small molecule binding one or more binding sites in the target protein. In some applications, however, the target is a nucleic acid molecule, such as the RNA molecule used as the target in the simulation described in Example 1, infra.

Ligand molecules which may be used to populate the interaction environment of the simulation are typically small molecules relative to the target molecule, such as a drug, metabolite or other small molecule ligand. In general, a small molecule is a low molecular weight organic compound, typically having a molecular weight of 800 Daltons or less. In some embodiments, the selected ligand molecules do not interact with each other. In some embodiments, the ligands are small peptides or small oligonucleotides.

In the practice of the method of the invention, the interaction environment is populated with the three dimensional structures of the target molecule and a plurality of ligand molecules. The three dimensional structures are represented by structural coordinates derived from experimentally-determined or computer-generated structures, or a combination thereof. For example, the three-dimensional structure of a molecule may be determined experimentally using x-ray crystallography to generate a “crystal structure” of the molecule. Other methods for determining three-dimensional structures include nuclear magnetic resonance, cryo electron microscopy, small angle x-ray scattering and the like, as will be understood by those skilled in the art. Computer modeling may also be used to approximate the three-dimensional structures of proteins and nucleic acids or complexes thereof, as is well known in the art. In addition, a combination of experimentally-derived and computer-modeled structural information may be used to provide the input structural coordinates to the interaction environment of the simulation.

The individual ligand molecules populating the interaction environment may be homogeneous (all molecules the same) or heterogeneous (two or more different ligand molecules).

Within a populated interaction environment system, a molecular dynamics simulation is conducted for a time sufficient for the simulation to converge, or attain a fully equilibrated system where the binding rate and/or map of free energy does not change. The interaction dynamics between one or more ligand molecules and the target molecule are recorded and observed. Molecular level simulations of the system are performed to gain insight into (i) which molecules bind more tightly, and (ii) the mechanism of binding within the system. In the method of the invention, binding occurs stochastically, as the method allows for stochastic motion of the ligand and target molecules. The method also allows for stochastic binding events. Here, binding events include random or stochastic collisions between the binding molecule and the target, in contrast to other methods that (i) start with the molecule already bound or nearly bound, or (ii) move the binding molecule to the target along a pre-determined or forced pathway.

Molecular dynamics simulation is a form of computer simulation in which atoms and molecules are allowed to interact for a period of time by approximations of known physics, giving a view of the motion of the particles. Molecular dynamics simulation methods and software are known and available for executing the simulation methods of the invention. In preferred embodiments, all-atom structure-based simulations are performed using the GROMACS software package (Lindahl E, Hess B, van der Spoel D. Gromacs 3.0: a package for molecular simulation and trajectory analysis. J Mol Mod 2001; 7: 306-317). GROMACS (GROningen MAchine for Chemical Simulations) is a molecular dynamics simulation package originally developed in the University of Groningen, now maintained and extended at different places, including the University of Uppsala, University of Stockholm and the Max Planck Institute for Polymer Research. GROMACS is open source software released under a General Public License. Other available molecular dynamics software packages include AMBER (“Assisted Model Building with Energy Refinement”), which is available through the University of California, San Francisco Campus (see also, Case et al., 2005, The Amber biomolecular simulation programs. J. Computat. Chem. 26:1668-1688).

The binding of a small molecule to a target (e.g. a drug binding to a protein) entails a competition between two effects: (1) enthalpy and (2) entropy. Enthalpic interactions include van der Waals interactions and electrostatic interactions. The enthalpy component of binding describes the “sticking” interactions between the small molecule and the target, or the strength of the “glue” between the small molecule and the target. This may include lock-and-key fit (i.e., shape complementarity) or electrostatic forces (e.g., electrostatic steering). The enthalpy contribution to the free energy is off-set by the second law of thermodynamics: the total entropy of an isolated system increases. Systems are more likely to be disordered than ordered. Therefore, the entropy contribution to binding is often approximately equal to or larger than the enthalpy contribution to the free energy. For example, in a system that includes only a drug and a target, the entropy is larger when the drug is not bound to the target. Here, the act of binding increases the order of the system and therefore decreases the entropy.

The method of the invention specifically includes the entropic component of the free energy in the populated interaction environment, by achieving sufficient configurational sampling and calculating the free energy explicitly using the formula, Delta_G(Q)=−kT log P(Q), where Delta_G is the change in free energy, k is Boltzmann's constant, T is the temperature and P is the probability that the system exists in state Q. Stochastic flexibility of the ligand molecule, the target and ligand-target interaction are included. Statistical sampling is generated for the ligand molecule conformation, the target conformation, the ligand molecule to target interactions and binding events. These effects allow for estimates of the binding free energy that explicitly include entropic effects, in contrast with other methods that do not explicitly include entropic effects. To be considered a binding event, the small molecule must spend some time away from the binding site between interactions with the binding site. In this context, “away” means at least three diameters of the ligand molecule. The term “diameter” in this regard means the length scale size of the ligand molecule, or the largest end-to-end dimension of the ligand molecule.

In one embodiment, the energy function (or, “Hamiltonian”) is as follows:

$$V = {\sum }_{bonds} {{ɛ}_{r} ( r - {r}_{0} )}^{2} + {\sum }_{angles} {{ɛ}_{θ} ( θ - {θ}_{0} )}^{2} + {\sum }_{impropers / planar} {{ɛ}_{χ} ( χ - {χ}_{0} )}^{2} + {\sum }_{backbone} {ɛ}_{BB} {F}_{D} ( φ ) + {\sum }_{sidechain} {ɛ}_{SC} {F}_{D} ( φ ) + {\sum }_{contacts} {ɛ}_{C} [ {( \frac{{σ}_{ij}}{r} )}^{12} - 2 {( \frac{{σ}_{ij}}{r} )}^{6} ] + {\sum }_{non \text{-} contacts} {{ɛ}_{NC} ( \frac{{σ}_{ij}}{r} )}^{12}$$

$$where , \\ {F}_{D} ( φ ) = [ 1 - cos ( φ - {φ}_{0} ) ] + \frac{1}{2} [ 1 - cos ( 3 ( φ - {φ}_{0} ) ) ]$$

When using an all-atom based model, the bond, angle, improper and planar terms maintain backbone geometry. Flexible dihedrals are given cosine terms. Non-local native interactions are given attractive 6-12 interactions and non-native interactions are given repulsive terms. A preferred all-atom model for proteins is described in Whitford et al., 2008, An all-atom structure-based potential for proteins: Bridging minimal models with all-atom empirical forcefields, Proteins: Structure, Function, and Bioinformatics 75(2): 430-441. In this model, only heavy (nonhydrogen) atoms are included. Each atom is represented as a single bead of unit mass. Bond lengths, bond angles, improper dihedrals, and planar dihedrals are maintained by harmonic potentials. Nonbonded atom pairs that are in contact in the native state between residues i and j, where i>j+3, are given a Lennard-Jones potential, whereas all other nonfocal interactions are repulsive.

Other protein models include the C-alpha model. The C-alpha model only has the bonds and angles terms to maintain backbone geometry. Dihedral angles are formed between 4 adjacent CA atoms and non-local contacts are included via a 12-10 potential, unlike the All-atom model which uses a 12-6 potential. For a complete description of the C-alpha model, see Clementi et al., 2000, J. Mol. Biol., 298: 937-953.

A preferred all-atom model for nucleic acids is described in Whitford et al., 2009, Nonlocal Helix Formation Is Key to Understanding S-Adenosylmethionine-1 Riboswitch Function, Biophys. J. 96(2): L7-L9. See also, Example 1, infra.

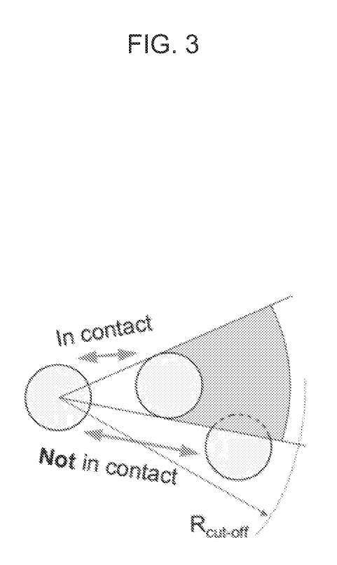

As will be appreciated by those skilled in the art, a contact map is an important component of a structure-based model. It is a symmetric matrix that encodes the tertiary structure of the molecule by defining the interactions that stabilize the native state, and is generated and used in the Hamiltonian, or energy function of the model. A common method of choosing these interactions is to choose a cut-off distance and define all atoms within the cut-off distance in the native state as the stabilizing interactions. The cut-off distance needs to be long enough to include all relevant short range interactions, for proteins ˜6 Å is generally sufficient. With a cut-off definition for contacts, in order to include the contacts between 5-6 Å, several “unphysical” contacts will be introduced. The unphysical contacts being those that are acting through another atom. To avoid this situation, a Shadow contact map (SCM) may be utilized. An exemplary SCM algorithm is represented in FIG. 3. This algorithm is a cut-off contact map with a screening term S introduced. All atoms are given a radius S. To determine the atoms contacting atom i, all atoms within a cut-off distance C of atom i are considered possible contacts. Those contacts which have an intervening atom are considered screened out and are discarded. The algorithm is simply stated: a light source is located at the center of atom i, any atoms within C which have no shadow cast upon them are considered contacts. One may change S to scale the amount of shadowing. S=1 Å works well with proteins.

For nucleic acids, a simple cut-off map is recommended. A cut-off map generates a list of contacts as determined by specified distances and sequence differences.

The exact balance between entropy and enthalpy determines how likely it is for the ligand to bind, leading to the free energy of binding. In addition to the entropy of a two body system for bound and unbound states, the populated interaction environment system is continuously bombarded by thermal fluctuations, through collisions with surrounding water molecules. Such thermal fluctuations add to the disorder in the system, affecting the conformation of ligand molecules, the conformation of the target, the number of binding events and the conformations of the ligand-target interactions. Collisions with water molecules may be simulated explicitly, by including three dimensional models of water molecules in the simulation, or implicitly, by including a stochastic collision term in the equations of motion. Whether or not the water is included implicitly or explicitly, the free energy is always, in the method of the invention, calculated explicitly by counting the number of states. Entropy is accounted for explicitly.

The method of the invention aims to identify ligands such as small molecules that bind tightly to a specified target molecule. By including entropy, the method also produces a better mechanistic understanding of the binding process. By testing various ligand molecules, the method can generate lead compounds for use in drug design. The method may also be used to evaluate a lead compound in relation to modified variants of the compound. Additionally, the method of the invention is particularly useful for studying the dynamic equilibrium between bound and unbound states. In certain cases, for example, a small molecule ligand will dissociate from the target after being bound for some amount of time. The ligand molecule may be replaced by another small molecule ligand that binds to the binding site of the target. In this manner, the equilibrium between bound and unbound states may be studied. In contrast, stochastic simulations that use only one ligand molecule have a much lower probability of generating multiple binding and dissociation events in a single simulation. In particular, once a small molecule dissociates, future binding events may be extremely rare. Thus, the method of the invention has the advantage of enabling the direct control of the number of binding events by increasing the number of ligand molecules in the interaction environment.

The method of the invention allows for the simulation of collisions between the ligand molecule and the target molecule. Unlike previously described models, in the method of the invention the initial position of the ligand molecule is far away from the target, as is the case in physiological binding events. By “far”, it is meant that the initial distance between the ligand molecule and the target is at least several times the diameter (i.e. length scale size) of the small molecule. In one embodiment, initial ligand positions have distances to the target binding site of at least three times the estimated diameter of the ligand. Because this distance is much larger than that used in conventional techniques, collision events are rare. Therefore, many ligand molecules are to be included in the simulation to increase the probability of collision with the target near the binding site. The inclusion of many ligand molecules makes this approach feasible.

In a related embodiment, the invention provides a method of simulating the interaction between a ligand and a target molecule, in which the molecular dynamics simulation is conducted across temperature-variable identical replicas of the populated interaction environment. More specifically, a plurality of computer-generated interaction environments which are identical except for temperature are provided in the model. Each interaction environment is presented with a different temperature, which will vary between the various interaction environments by a temperature interval, such that the full complement of all interaction environments used in the simulation represents a temperature range. In general, the temperature range represented by the full complement of interaction environments is user-selected to maximize configurational sampling, and therefore the accuracy of the entropic contribution to the free energy. In most embodiments, a range of between 265 and 550 degrees Kelvin is useful for studying the interaction dynamics between a ligand or ligands and the target. Preferably, the temperature interval will be between one-tenth of a degree and 20 degrees Kelvin. Other variables aside from or in addition to temperature may be used, such as pressure or interaction potential strength.

The methods of the invention may further comprise the generation of a physical representation of all or part of the simulation. In one embodiment, the physical representation is of the interaction between a ligand molecule and the target molecule. In another embodiment, a set of physical representations are generated and combined to form a temporal representation of all or part of the simulation. A physical representation may be any computer-generated image or series of images or combined images, such as a two dimensional image, a series of two-dimensional images, a movie, or numerical data which display or represent the interaction. The manifestation of the physical representation may reside and/or be presented on a computer screen, a database, or a printed image, as well as electronic media capable of storing the same and providing for the retrieval thereof.

### EXAMPLES

### Example 1

### All-Atom Structure-Based Simulation Applied to RNA

In this example, the method of the invention was applied to the SAM-I riboswitch target. Application of the method of the invention to SAM-I riboswitch function revealed critical and heretofore unknown elements of folding, ligand binding and activation of this functional RNA molecule.

Materials and Methods were as presented in the Supplementary Materials of Whitford et al., 2009, supra, hereby incorporated by reference herein in its entirety. Results of this Example are presented in Whitford et al., 2009, supra, hereby incorporated by reference herein in its entirety.

All publications, patents, and patent applications cited in this specification are herein incorporated by reference as if each individual publication or patent application were specifically and individually indicated to be incorporated by reference.

The present invention is not to be limited in scope by the embodiments disclosed herein, which are intended as single illustrations of individual aspects of the invention, and any which are functionally equivalent are within the scope of the invention. Various modifications to the models and methods of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

What is claimed is:

1. A method of simulating the interaction between a ligand and a target molecule, comprising:
a. providing a computer-generated interaction environment having volumetric dimensions as large or larger than the known or predicted maximum volume of the target molecule;
b. populating the interaction environment with the three-dimensional structure of a single target molecule and a plurality of ligand molecules, wherein the ligand molecules are positioned at least three times the estimated diameter of the ligand molecule from the target molecule; and,
c. conducting a molecular dynamics simulation, in which the free energy includes entropy, and observing the interaction dynamics between one or more ligand molecules and the target molecule.

2. The method of claim 1, wherein the molecular dynamics simulation is conducted for a time sufficient for the simulation to converge.

3. The method of claim 1, wherein the three-dimensional structures of the target and ligand molecules are derived using experimentally-derived or predicted structures or a combination thereof.

4. The method of claim 1, wherein the interaction dynamics include binding events.

5. The method of claim 4, wherein a distance of 4 angstroms between a ligand molecule and the target molecule represents a binding event.

6. The method of claim 1, wherein the plurality of ligand molecules are randomly placed within the interaction environment.

7. The method of claim 1, wherein the individual ligand molecules populating the interaction environment are homogeneous.

8. The method of claim 1, wherein the individual ligand molecules populating the interaction environment are heterogeneous.

9. The method of claim 1, wherein at least 10 individual ligand molecules populate the interaction environment.

10. The method of claim 1, wherein the ligand molecules do not interact with each other.

11. A method of simulating the interaction between a ligand and a target molecule, comprising:
a. providing a plurality of computer-generated interaction environments which are identical except for temperature, wherein each interaction environment has a volumetric dimension as large or larger than the known or predicted maximum volume of the target molecule, and wherein the plurality of interaction environments represents a temperature range;
b. populating each interaction environment with an identical set of molecules comprising a single target molecule and a plurality of ligand molecules wherein the ligand molecules are positioned at least three times the estimated diameter of the ligand molecule from the target molecule; and,
c. conducting an identical molecular dynamics simulation within each interaction environment, in which the free energy includes entropy, observing the interaction dynamics between one or more ligand molecules and the target molecule, and comparing the interaction dynamics among the plurality of interaction environments.

12. The method of claim 11, wherein the temperature range is between 265 and 550 degrees Kelvin.

13. The method of claim 12, wherein the intervals within the temperature range is between one-tenth of a degree and 20 degrees Kelvin.

14. The method of claim 1, further comprising generating a physical representation of the interaction between a ligand molecule and the target molecule.

15. The method of claim 14, wherein the physical representation is selected from the group consisting of a two dimensional image, a series of two-dimensional images, a movie, and numerical data which display or represent the interaction.

16. The method of claim 11, further comprising generating a physical representation of the interaction between a ligand molecule and the target molecule.

17. The method of claim 16, wherein the physical representation is selected from the group consisting of a two dimensional image, a series of two-dimensional images, a movie, and numerical data which display or represent the interaction.

18. The method of claim 11, wherein the ligand molecules do not interact with each other.
